(19) United States
(12) Patent Application Publication
(10) Pub. No.: US 2004/0057040 A1
(43) Pub. Date: Mar. 25, 2004

(54) Method and device for identifying chemical substances

(76) Inventors: Konrad Beckenkamp, Seeheim (DE); Oliver Mandal, Wuppertal (DE); Karl Molt, Wesel (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/296,581

(22) PCT Filed: May 7, 2001
(86) PCT No.: PCT/EP01/05127

(30) Foreign Application Priority Data
May 26, 2000 (DE) 100 26 195.7

(51) Int. Cl. G01J 3/44; G01N 21/00

(52) U.S. Cl. 356/73; 356/301; 250/339.07

(57) ABSTRACT

The invention relates to a method for identifying chemical substances, comprising the following steps: analyzing a group of reference substances using a first method of analysis and a second, different method of analysis, especially NIR and Raman spectroscopy; storing the first and second sets of characteristic properties obtained for each reference substance and the combined sets of characteristic properties obtained by combining said first set and said second set, in a reference data base; analyzing the substance to be analyzed with the first and second methods of analysis; comparing the combined set of characteristic properties of the substance to be analyzed with the combined sets of the reference substances; identifying the substance to be analyzed with one of the reference substances when the similarity between the combined set of the substance to be analyzed and the combined set of exactly one reference substance, as established according to a set scale, exceeds a predetermined threshold value.

The present invention relates to a method for identifying chemical substances, with the following steps.

a) analysing a group of reference substances using a first method of analysis and obtaining a first set of characteristic properties for each reference substance,

b) memorising a first set of characteristic properties in a reference data bank,

c) obtaining a set of characteristic properties of a substance to be analysed with the aid of the first method of analysis,

d) analysing the group of reference substances using a second method of analysis different from the first one in order to obtain a second set of characteristic properties for each of the reference substances that differs from the first set of characteristic properties, and repetition of steps b) and c) with respect to the second method of analysis.

The present invention also relates to a corresponding device that is suitable for implementing such a method.

Such methods and devices are already known in principle. The main methods of analysis for consideration are all spectroscopic methods such as NIR and IR spectroscopy (near and mid-range infra-red spectroscopy) Raman, UV, NMR, MS (mass spectroscopy), X-ray spectroscopy and fluorimetry. The devices have appropriate spectrometers for implementing the spectroscopic analysing.

In chemical works that manufacture and/or use a large number of different chemical substances, where the individual chemical substances can also be in very different forms, for example, solid, liquid or gaseous, large-particle, powdery or in blocks, and so forth, the problem of accurately identifying a given substance often occurs. Such a problem may arise, for example, because labels on containers fall off or are removed or forgotten, because quantities of substances are spilled without note being taken immediately as to which container the substances were lost from, and lastly, appropriate analysis is also carried out for monitoring identity, and possibly for quality control of substances that are, in principle, known. Clearly, there are also mixed substances that respectively contain proportions of different basic substances. The actual state (solid, liquid, gaseous) and also the fact of whether the material is more powdery or more large-particled (morphology) also have an influence on the characteristic properties obtained within the framework of an actual method of analysis such as, for example, the shape of individual bands or lines and their intensity in a spectrum. While the problem is obvious in the case of spilled substances and labels that have fallen off, there is a permanent risk that, for example, wrong or erroneous labels have been used or a swap has taken place. Within the framework of a maximum standard of safety, comprehensive monitoring is therefore recommended (monitoring of each sample to be processed). A far greater number of measurements must therefore be undertaken than was previously the case. The duration of measurements and their evaluation thus also play a significant role in the workability of a method of identification.

As is known, different substances also have different spectra, that is to say lines (absorption or emission lines) at different wavelengths and of different intensity. The majority of lines at very specific wavelengths (frequencies) and their relative intensity generally provide a clear “fingerprint” for a given chemical substance.

The differences between these various “fingerprints” get smaller, however, the more similar the substances involved are to one another.

The spectra of substances that differ only in their morphology (crystal structure, external state) are yet more similar, for example when one and the same substance is present as a solid body, as large-particle material or as a fine powder. In these cases the spectra are, in principle, identical, but are nevertheless affected by the surface effects. Molecules and atoms in the interior of a solid body have a different external environment than on the surface of the solid body, so because of this difference and because of the clearly different surface/volume ratio between, for example, large-particle and fine powder, the spectral lines either shift or become wider, or relative intensities even change.

Furthermore, substances employed in the chemical industry are also in the form of mixtures of different chemical components, so the spectra of the individual components show up overlapping, but the relative intensities depend upon the mixture ratio. All these different conditions clearly make definite identification of chemical substances more difficult. A single spectroscopic measurement is therefore often insufficient to be able to say, from the spectroscopic results, which chemical substance, out of a large number of substances, is involved, certainly at least when the substances in question have very similar spectra.

It has already been attempted in the past to improve the meaningfulness of spectroscopic measurements in that independent spectral measurements have been taken, for example an NMR (nuclear magnetic resonance) spectroscopy in addition to infrared spectroscopy. Raman spectroscopy is often done in addition to an IR spectroscopy as the two spectra contain complementary data. Raman spectroscopy provides additional spectral lines for a given substances, which are independent of those in IR spectroscopy, and so in this way an additional set of characteristic features is obtained that can contribute to further discrimination of other chemical substances.

However, even this is not always sufficient for definitely identifying chemical substances. When the state, colour or particle size of the substances in question provide no further clues to the identity of a substance, finally only chemical analysis remains as the last, but very expensive, means of identifying a substance present.

With respect to this prior art, the object of the present invention is to provide a method and a corresponding device that enable improved differentiation of different, although sometimes very similar, substances, using simple means.

In accordance with the invention this object is solved, in the case of the method described in the introduction, in that is additionally has the following features:

e) combination of the first and second sets of characteristic properties of the reference substances into a combined set of characteristic properties and memorisation of this combined set,

f) combination of the correspondingly combined set of N characteristic properties for the substances to be analysed,

g) establishment of a standard for the similarity between the combined set of characteristic properties of the substance to be analysed and the combined set of characteristic properties of the reference substances,

h) comparison of the set of characteristic properties of the substance to be analysed with the combined set of characteristic properties of the reference substances, and

i) identification of the substance to be analysed with one of the reference substances when the degree of similarity between the combined set of characteristic properties of the substance to be analysed and the combined set of characteristic properties for precisely one of the reference substances involved exceeds a pre-determined threshold.

Unlike the prior art, two independent identification measurements do not take place in which the degree of similarity between the substance to be analysed and corresponding reference substances is in each case determined independently, and the results then combined with one another, but instead the results of the measurements are combined into a single set of characteristic properties, and on the basis of the single set there is firstly a definition of the similarity with a corresponding single set of combined characteristic properties of reference substances.

It has been shown that combination of the sets of characteristic properties prior to comparison of similarity or respectively of identity with reference substances results in a higher rate of accuracy that subsequent combination of results from separate, independent measurements. In particular when the selected methods of analysis involve very different principles it may be necessary to carry out data pre-processing or transformation, or reduction, so that the two sets of characteristic properties can actually be combined into a common set of properties. Such pre-processing, transformation or reduction of data can be done, for example, in the form of a so-called wavelet transformation, and in the simplest case by establishing a binary string for the presence or absence of certain properties. In the case of an IR or Raman spectrum the respective frequencies or wavelength intervals analysed can simply be divided into a large number of smaller segments and the presence of a spectral line in a given segment is then recognised as given when the spectral value measured in this segment is above a pre-determined limit value, and the property is recognised as absent when the spectral value is below this limit value. In this way a so-called binary string is obtained for the entire spectrum. In principle this can be carried out completely regardless of the method of measurement, so Raman spectra and NIR spectra both result in the same way in binary strings that can very easily be combined to form a single binary string. Other spectral measurements could also be converted in the same way into binary strings so that a single combined data set can be produced very easily. Nevertheless, a portion of the data present in the spectrum per se, that is to say in particular the relative intensities of different lines, is lost. However, other forms of data reduction or transformation enable the data content relating to relative intensities to be adopted into the single set of characteristic properties. Wavelet transformation, which corresponds to section-by-section Fourier transformation, is particularly relevant here.

It is moreover also possible to give different weightings to individual sections of the spectra or respectively individual data values or ranges, as measurements in certain ranges are possibly more precise than in other ranges, or because, for example, one method of measurement generally has a better power of differentiation for a given chemical substance than another one. Such weighting can possibly also be done automatically dependent upon measured values obtained, or respectively the quality thereof.

In the preferred embodiment of the invention, definition of the similarity of two chemical substances is done by assignment of the set of N characteristic properties to an N dimensional vector, wherein the similarity is given by calculating the gap between two corresponding vectors that are derived from two sets of characteristic properties that are to be compared. An identity is established when the two vectors (vector peaks) lie within a predetermined range of distances apart.

Such a range of distances apart is determined using the reference substance in that several samples of one and the same reference substance is measured a plurality of times, and from these different measurements respective corresponding sets of characteristic properties are produced, which can be converted, for example, into vectors in an N dimensional vector space. In this way a specific variance is produced in the measurement of one and the same substance. Measurements of the same substance can possibly be of different morphologies, that is to say in powdery or large-particle form, and either be included in the variance or assigned to ranges of similarity separated for discriminating between powder and large-particle materials. Clearly, this is assuming that the variance between reference substances in the same group (same morphology) is not greater than the gap between the average values of the two groups of reference substances of different morphology.

With respect to the method according to the invention, however, it has essentially been shown that when the data basis is increased, that is to say when there is an increase in the number N of characteristic properties, and thus a corresponding widening of the vector space, the variance measured with respect to a given reference substance (when measuring different samples of one and the same substance) increases less strongly than the gaps between the average values of different, and in particular only slightly different, reference substances. In this way, prior combination and unification of data sets delivers a certain “synergy effect” over the statistics.

When differentiation (for example, of different morphology of a chemical substance) is nevertheless not possible in this way, the different reference substances are more meaningfully combined to form an identification group. In identifying a substance that is actually to be analysed that is assigned to the same identification group, its assignment to a specific reference substance can possibly be done by means of additional examination as, for example, large-particle and powdery material is easy to differentiate, so that definitive assignment can then finally take place.

Before establishing the set of characteristic properties, the raw data from the measurement can also possibly be further prepared. For example, under certain conditions correction by a base or background signal can or must be made. This can be done, for example, by subtracting a blank channel or by forming the first or second derivation of a measured spectrum. By forming the first derivation, a constant background signal is removed. By forming the second derivation, a background signal is removed that varies monotonously across the spectral range, while the remaining meaningful structures of the spectrum are substantially retained.

An embodiment of the method according to the invention is particularly preferred in which the similarity between a substance to be analysed and the accompanying reference substances is displayed visually on a display device, for example, on a two-dimensional table.

The invention will now be described with reference to an embodiment and the attached drawings. There is shown, in:

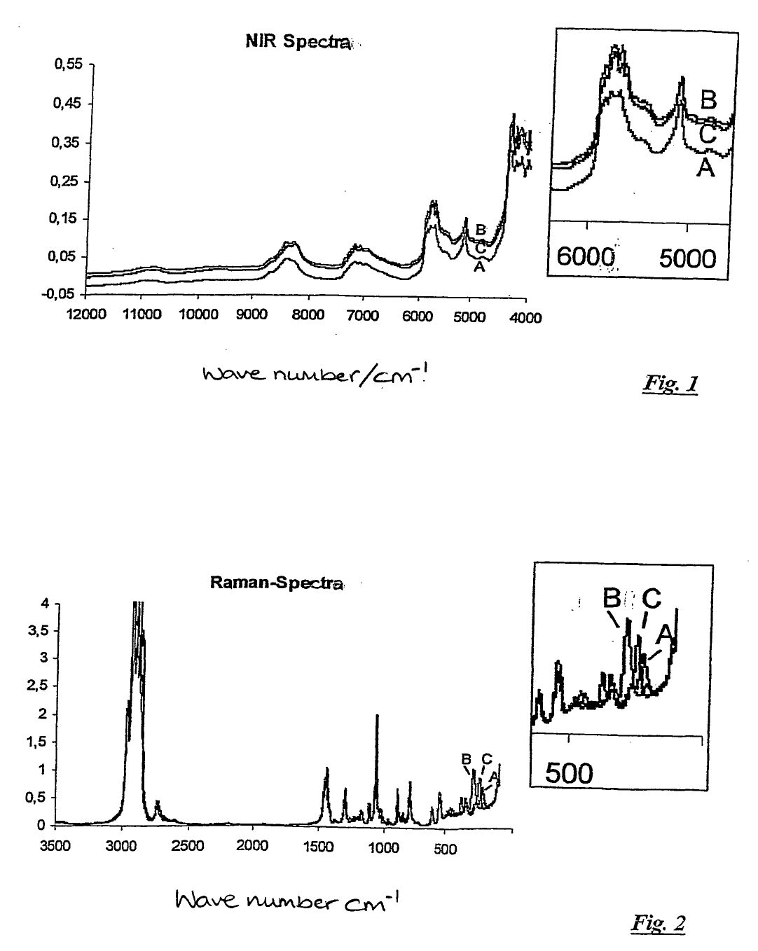

FIG. 1 the NIR spectra of three chemically closely related sodium salts,

FIG. 2 the Raman spectra of the sodium salts of FIG. 1,

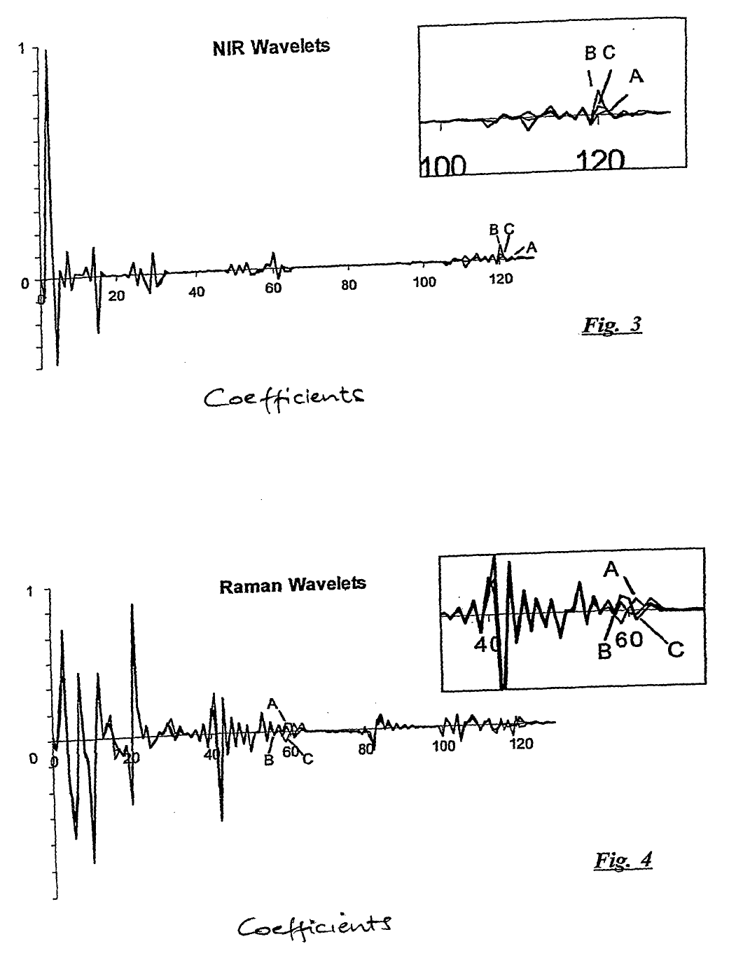

FIG. 3 a wavelet transformation of the NIR spectra of FIG. 1, and an enlarged section thereof,

FIG. 4 the wavelet-transform of the Raman spectrum of FIG. 2,

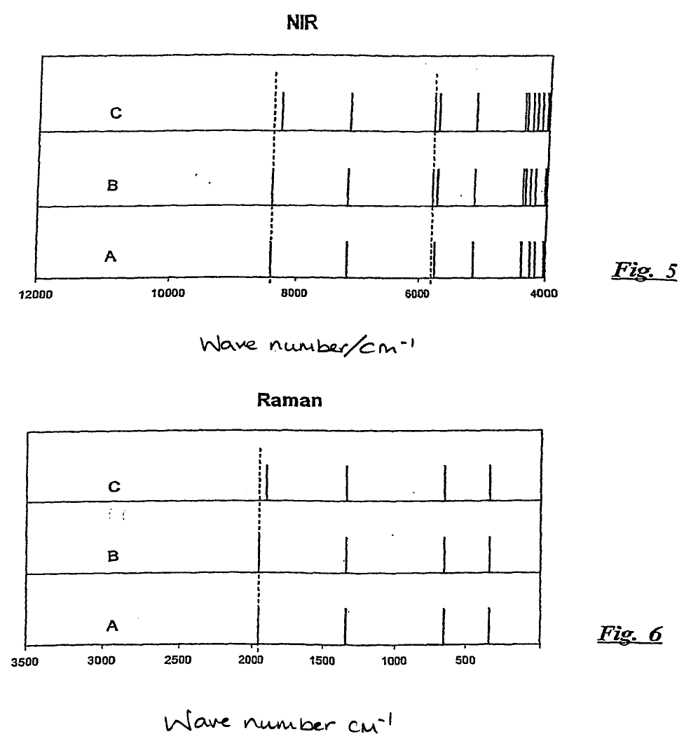

FIG. 5 the three spectra of FIG. 1 after binary encoding,

FIG. 6 the three spectra of FIG. 2 separated after binary encoding, and

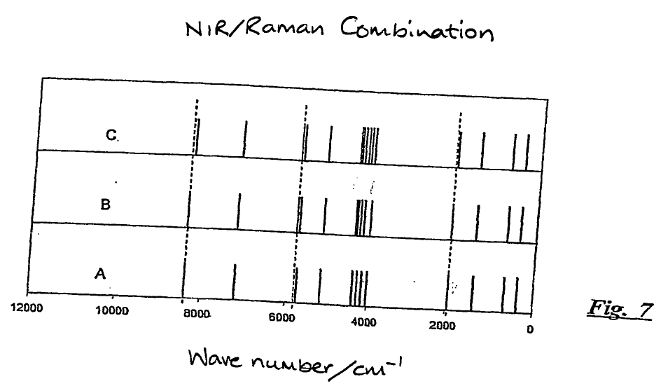

FIG. 7 the combination of the binary encoded spectra according to FIGS. 1 and 2.

FIG. 1 shows the NIR spectra of the sodium salts of pentane sulphonic acid (A), hexane sulphonic acid (B) and heptane sulphonic acid (C). A portion of the spectra is shown enlarged to the right in FIG. 1 in order to show the slight differences between these three spectra, A, B and C. It is to be noted that a vertical shift in the spectra or multiplication of the spectra by fixed factors does not normally contribute to differentiating the spectra, as only the position of the individual lines, and optimally their relative intensities, are a half-way reliable clue as to the identity of a substance. Consequently, the shifting of line A compared to lines B, C is not a sufficient criterion for differentiation.

As can be seen, the different lines A, B, C are extraordinarily similar to one another. This is also the case with the Raman spectra shown in FIG. 2. Here too, marginal differences at one point can only be seen in an enlarged section shown on the right.

The bands in the Raman spectra between 2900 and 3000 cm⁻¹, for example, are also not very suitable for evaluation as they are very intensive, so the limits of the detector will be reached in sensing them. In the range between 100 and 500⁻¹, in principle a differentiation between the spectra is possible, however the differences are very slight in this case too, and are insufficient for definite identification within a group of, for example, approximately 1000 substances. Direct combination of the two spectra is impossible as the absolute intensities of the spectra clearly differ.

The easiest way to combine the two spectra with one another, and to evaluate the combined spectra, is, for example, by binary encoding. Such binary encoding is carried out both for the NIR spectra of FIG. 1 and the Raman spectra of FIG. 2. The results of the binary encoding are shown in FIGS. 5 and 6 respectively. Because of the similarity between the original spectra, clearly the binary encoded spectra are also still very similar to one another. However, they have the advantage that they can be combined directly with one another, that is to say the binary encoded spectra of FIGS. 5 and 6 can easily be represented in a common spectrum, as is the case in FIG. 7. In this way the NIR and Raman spectra can be jointly evaluated, whereby for statistical reasons there is a greater significance for discrimination results.

In FIGS. 3 and 4, wavelet transforms of the NIR spectra of FIG. 1 and respectively of the Raman spectra of FIG. 2 are shown. In this case too, it can be seen that the differences in the transforms are relatively slight.

The two transforms according to FIG. 3 and FIG. 4 can, however, again be directly combined and evaluated in combination with one another, so in this way a better possibility for differentiation is again produced, even when each of the spectra per se possibly does not definitely provide this differentiation.

1. Method for identifying chemical substances with the following steps:
a) analysing a group of reference substances using a first method of analysis, and establishing a first set of characteristic properties for each of the reference substances,
b) memorising the first set of characteristic properties in a reference data bank,
c) establishing a set of characteristic properties of a substance to be analysed with the aid of the first method of analysis,
d) analysis of the group of reference substances with a second method of analysis different from the first one, in order to establish a second set of characteristic properties for each of the reference substances, that differs from the first set of characteristic properties, and repetition of steps b and c for the second method of analysis,
characterised by the features of:
e) combination of the first and second sets of characteristic properties of the reference substances to form a combined set of characteristic properties, and memorising of the combined set,
f) combination of the correspondingly combined set of N characteristic properties for the substance to be analysed,
g) establishment of a standard for the similarity between the combined set of characteristic properties of the substance to be analysed and the combined set of characteristic properties of the reference substances,
h) comparison of the sets of characteristic properties of the substance to be analysed with the combined set of characteristic properties of the reference substances,
i) identification of the substance to be analysed with a reference substances when the similarity between the combined set of characteristic properties of the substance to be analysed and the combined set of characteristic properties for precisely one of the reference substances concerned exceeds a pre-determined threshold.

2. Method according to claim 1, characterised by the assignment of several reference substances to an identification group when the degree of similarity between the combined set of characteristic properties of the substance to be analysed and the combined set of characteristic properties at the same time exceeds the pre-determined threshold for these several reference substances.

3. Method according to claim 1 or 2, characterised in that data reduction for the first and/or second set of characteristic properties is done for both the reference substances and for the substances to be analysed.

4. Method according to claim 3, characterised in that the data reduction is in the form of a wavelet transformation.

5. Method according to claim 3, characterised in that the data reduction is done by establishing a binary string for the presence or absence of the characteristic properties.

6. Method according to one of claims 1 to 5, characterised in that one of the first or second methods of analysis is NIR spectroscopy.

7. Method according to one of claims 1 to 6, characterised in that one of the first or second methods of analysis is Raman spectroscopy.

8. Method according to one of claims 6 or 7, characterised in that different weighting of different ranges of an NIR and/or Raman spectrum is performed for establishing data sets and/or comparing different data sets.

9. Method according to one of claims 1 to 8, characterised in that the definition of similarity/gap terms by assigning the set with a whole number of N characteristic properties to an N-dimensional vector, and calculation of the gap between two vectors derived from sets of characteristic properties that are to be compared.

10. Method according to one of claims 1 to 9, characterised by repeated establishment of the combined set of characteristic properties of reference substances that are chemically and/or physically the same, and calculation and establishment of the variance produced from results that differ from one another.

11. Method according to one of claims 1 to 10, characterised by establishment of a range of similarity by it being greater by a factor of between 1 and 3 than the measured variance.

12. Method according to one of claims 1 to 11, characterised by establishment of a range of similarity by each of the reference substances that are chemically and/or physically the same being within the range of similarity.

13. Method according to one of claims 1 to 12, characterised by combination of several reference substances into an identification group when the average values of combined sets of characteristic properties for these several reference substances respectively fall within the range of similarity for another reference substance from the same group.

14. Method according to one of claims 1 to 13, characterised by data correction by a base signal.

15. Method according to claim 14, characterised in that the base signal is taken into consideration by forming the first and/or second derivation.

16. Method according to one of claims 1 to 15, characterised in that establishing the sets of characteristic properties for a large number of substances potentially to be analysed, and comparison with all or a portion of the sets of reference data, results in an evaluation of the capacity for and/or sensitivity of discrimination of the method, whereby in the case of a capacity for discrimination that is too low, the criteria for similarity are intensified, and in the case of sensitivity that is too low, the requirements for similarity are reduced.

17. Method according to one of claims 1 to 15, characterised in that the similarity between one of the substances to be analysed and the reference substances is represented visually on a display means.

18. Method according to one of claims 1 to 16, characterised in that the substances to be analysed and the reference substances are solids.

19. Device for identifying chemical substances with:
an NIR spectrometer
a Raman spectrometer
at least one measurement space with means for recording NIR and Raman spectra
a storage means for capturing and storing spectral data that are each assigned to one substance
a microprocessor, and
a stored evaluation program for implemented a method according to one of claims 1 to 18.
